(19) United States
(12) Patent Application Publication
(10) Pub. No.: US 2025/0279464 A1
(43) Pub. Date: Sep. 4, 2025

(54) BATTERY MODULE FOR WORK MACHINE

(71) Applicant: Caterpillar Inc., Peoria, IL (US)

(72) Inventor: Richu Gheevarghese Samuel, Charumoodu Alappuzha (IN)

(73) Assignee: Caterpillar Inc., Peoria, IL (US)

(21) Appl. No.: 18/594,489

(22) Filed: Mar. 4, 2024

(51) Int. Cl. H01M 10/04; H01M 10/0525; H01M 10/6557; H01M 50/209; H01M 50/211

(52) U.S. Cl. CPC H01M 10/0468; H01M 10/6557; H01M 10/0525; H01M 50/209; H01M 50/211; H01M 2220/20

(57) ABSTRACT

A battery module is disclosed. The battery module comprises: a frame; a plurality of lithium-ion cells provided in the frame; a compression plate attached to the frame and configured to apply a uniform compression pressure to the plurality of lithium-ion cells in the frame; and a stopper for holding the compression plate at a holding location for maintaining pressure.

### TECHNICAL FIELD

The present disclosure generally relates to battery modules, and more particularly relates to compression of lithium ion cells in battery modules.

### BACKGROUND

Lithium-ion (Li-ion) cells, integral to numerous modern technologies, are available in various forms, including cylindrical, prismatic, and pouch cells. Each form exhibits distinct structural and operational characteristics. Cylindrical cells are particularly noted for their robustness against cyclic and through-life expansions. In contrast, prismatic, blade, pouch, or similar cells, due to their construction, do not exhibit the same resilience, posing challenges in terms of durability and longevity. The assembly and operational efficacy of prismatic, blade, pouch, or similar cells Li-ion cells are heavily contingent on maintaining optimal compression. This requirement is critical to ensure safety, reliability, and maximum life of these cells.

Currently, this is achieved through a cell stack structure predominantly comprising two end plates and various restraining members. These restraining members are responsible for maintaining the necessary compression between the endplates and come in different forms, such as sheets welded or riveted to endplates, straps wound around endplates, metal strips strapped over endplates, and tie rods used to bolt two endplates together.

Despite the critical role of compression in the performance of prismatic, blade, pouch, or similar cells, the current methods of achieving this compression exhibit several shortcomings. The “box in box” construction of the battery module, a common approach in current designs, leads to a reduction in both volumetric and gravimetric energy density. This construction style also results in increased thermal resistance between the cell surface and cooling plate or, alternatively, a reduction of the cooling surface due to the restraining members. Additionally, this approach increases the complexity of the design, evidenced by an increased number of parts and a lack of precise control over the compression force. This lack of control is often due to the variability introduced by factors such as the restraining member's settling stress under tension.

Existing designs of battery modules in work machines suffer from inefficiencies due to their complex construction leading to decreased energy densities and challenges in thermal management, exacerbated by the increased number of components and the inherent design's inability to precisely control compression forces. The inability to control compression forces in the battery module reduces performance and reliability in existing battery modules used in work machines due to demanding operational environments of heavy-duty work machinery like excavators.

Others have attempted to develop an effective design for Li-ion compression, but fail to provide an efficient design for maintaining Li-ion compression. For example, U.S. Pat. No. 9,559,378 discloses a fuel cell that includes unit cells that are stacked, a case that houses the cell stack, and a pressure plate that is placed in the case in the stacking direction to compress the cell stack by a plurality of load adjusting screws. The use of multiple load adjusting screws in U.S. Pat. No. 9,559,378 for compressing the cell stack introduces complexity and inefficiency. Manual tuning of each screw is time-intensive and may result in uneven pressure, hindering uniform compression. This approach struggles to uniformly address cell expansion and contraction, potentially causing inconsistent stress distribution and impacting the cells' longevity and performance.

It can therefore be seen that a need exists for an improved solution in Li-ion cell compression design that simplifies the compression process, ensures uniform pressure distribution, and accommodates the natural expansion and contraction of cells during their lifecycle.

### SUMMARY

In accordance with one aspect of the disclosure, a battery module is disclosed. The battery module comprises: a frame; a plurality of lithium-ion cells provided in the frame; a compression plate attached to the frame and configured to apply a uniform compression pressure to the plurality of lithium-ion cells in the frame; and a stopper for holding the compression plate at a holding location for maintaining pressure.

In accordance with one aspect of the disclosure, a system is disclosed. The system comprises a work machine; and a battery module for powering the work machine. The battery module includes: a frame; a plurality of lithium-ion cells provided in the frame; a compression plate attached to the frame and configured to apply a uniform compression pressure to the plurality of lithium-ion cells in the frame; and a stopper for holding the compression plate at a holding location for maintaining pressure

In accordance with another aspect of the disclosure, a method for assembling a lithium-ion battery module is disclosed. The method comprises positioning a plurality of lithium-ion cells within a frame of a battery module; installing a front cover on a first end of the frame, a back cover on a second end of the frame, and a compression plate between the plurality of lithium-ion cells and the back cover; and securing the compression plate in place, via a stopper, to apply a compression pressure on the plurality of lithium-ion cells to mitigate bulging of the plurality of lithium-ion cells within the frame.

These and other aspects and features of the present disclosure will be better understood upon reading the following detailed description when read in conjunction with the accompanying drawings.

### BRIEF DESCRIPTION OF THE DRAWINGS

FIG. 1 is a perspective view of a work machine, according to an embodiment of the present disclosure.

FIG. 2 is a perspective view of a battery module with a single column, according to an embodiment of the present disclosure.

FIG. 3 is a perspective cut-away view of a Li-ion cell for use in the battery module of FIG. 2, according to an embodiment of the present disclosure.

FIG. 4 is a pack of Li-ion cells of FIG. 3 for use in the battery module of FIG. 2, according to an embodiment of the present disclosure.

FIG. 5 is a compression plate for use in the battery module of FIG. 2, according to an embodiment of the present disclosure.

FIG. 6 is a perspective cut-away view of the battery module taken along line 6-6 of FIG. 2 containing a pack of Li-ion cells, according to an embodiment of the present disclosure.

FIG. 7 is a cross-sectional view of the of the battery module of FIG. 2, taken along line 7-7 of FIG. 6, according to an embodiment of the present disclosure.

FIG. 8 is a shim for use in the battery module of FIG. 2, according to an embodiment of the present disclosure.

FIG. 9 is a perspective view of the battery module of FIG. 2, according to another embodiment of the present disclosure.

FIG. 10 is a perspective close up of an end of the battery module of FIG. 2, according to an embodiment of the present disclosure.

FIG. 11 is a top cross-sectional view of a multi-pack battery module, according to an embodiment of the present disclosure.

FIG. 12 is a perspective cut-away view of the multi-pack battery module taken along line 12-12 of FIG. 11, according to another embodiment of the present disclosure.

FIG. 13 is a flow-chart of a method of assembling a lithium-ion battery module, according to an embodiment of the present disclosure.

FIGS. 14 is a perspective view of the frame of the battery module of FIG. 1, according to another embodiment of the present disclosure.

FIGS. 15 is a perspective view of the frame of the battery module of FIG. 11, according to another embodiment of the present disclosure.

The figures depict one embodiment of the presented disclosure for purposes of illustration only. One skilled in the art will readily recognize from the following discussion that alternative embodiments of the structures and methods illustrated herein may be employed without departing from the principles described herein.

### DETAILED DESCRIPTION

Referring now to the drawings, and with specific reference to the depicted example, a work machine 10 is shown, illustrated as an exemplary excavator. Excavators are heavy equipment designed to move earth material from the ground or landscape at a dig site in the construction and agricultural industries.

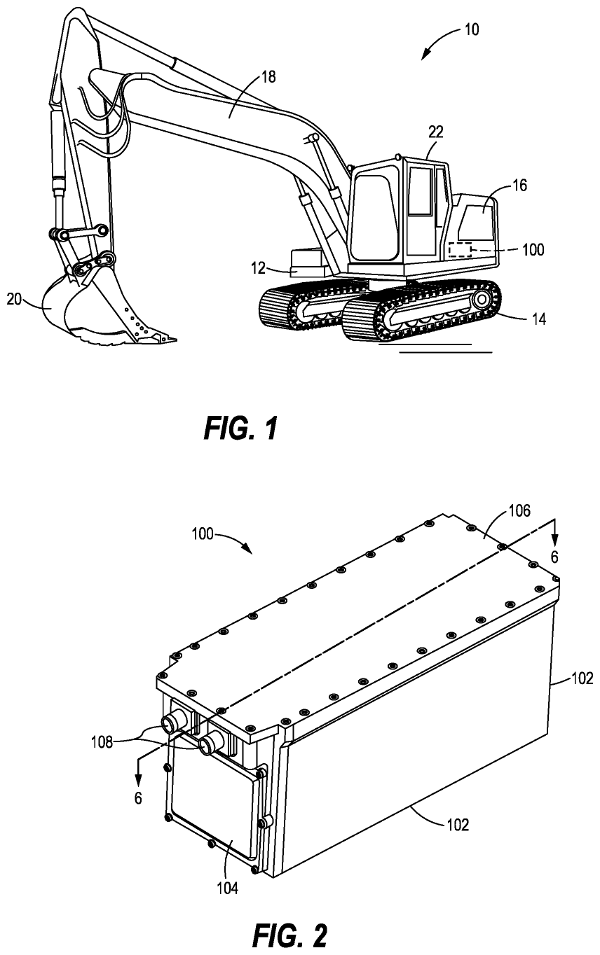

Referring now to FIG. 1, the work machine 10 comprises a frame 12. The frame 12 is supported on ground engaging elements 14, illustrated as continuous tracks. It should be contemplated that the ground engaging elements 14 may be any other type of ground engaging elements 14 such as, for example, wheels, etc. The work machine 10 further includes a prime mover 16 in the frame 12, a work implement 18 extending from the frame 12 for conducting work with a work tool 20, such as, for example, excavating landscapes or otherwise moving earth, soil, or other material at a dig site, and a cab 22 for operator personnel to operate the work machine 10. The prime mover 16 may be an engine or electric motor, as generally known in the arts.

The work machine 10 may further comprise a battery module 100, exemplified as a Lithium-ion battery assembly, for powering operations of the work machine 10, the ground engaging elements 14, the prime mover 16, and the work implement 18. The battery module 100 may replace the prime mover 16 or be provided in conjunction with the prime mover 16 in the work machine 10.

Lithium-ion battery assemblies are critical in providing power for a wide range of applications, from portable electronics to electric vehicles and renewable energy systems. While the following detailed description illustrates an exemplary embodiment in connection with a standard energy storage system, it should be understood that the principles and applications of the present disclosure extend to various other systems, devices, including, but not limited to, portable electronic devices, electric vehicles, industrial machinery, and grid storage solutions, among others. Furthermore, while the following detailed description describes an exemplary aspect of the battery module 100 in connection with the excavator, it should be appreciated that the description applies equally to the use of the present disclosure in other work machines, including, but not limited to, backhoes, front-end loaders, shovels, draglines, skid steers, wheel loaders, and tractors, as well.

Referring now to FIG. 2, the battery module 100, is shown in a perspective view, according to one embodiment of the disclosure. The battery module 100 comprises a frame 102 that serves as the foundational framework for the battery module 100. The frame 102 may include a single column that is designed to house multiple types of Li-ion cells and to facilitate the compression and maintenance of said cells within a single column formed by the frame 102. The frame 102 may be formed in a module structure and as a unitary frame to help reduce leakage by having a uniform frame.

The frame 102 is engineered in a single column to accommodate a variety of lithium-ion cells, addressing the need for versatility in application. Additionally, the battery module 100 includes a front cover 104 and a top cover 106, offering protection and maintaining the integrity of the internal components. The battery module 100 also comprises battery terminals 108, including both positive and negative terminals, essential for establishing electrical connections, as generally known in the arts. The design of the battery module 100 facilitates ease of assembly and enhanced compression capabilities. This is particularly significant in addressing the common issue of bulging 306 in lithium-ion batteries for improved performance and energy longevity in the battery module 100. The structure of the battery module 100 structure ensures that the Li-ion cells 300 are held securely, mitigating the risks associated with cell expansion over time. The frame 102 may be made from steel, metal, or other material that maintains the structure of the frame 102 to limit the bulging 306, as generally known in the arts. The front cover 104 and top cover 106 may be welded, bolted, soldered, or otherwise sealed to the frame 102, as generally known in the arts.

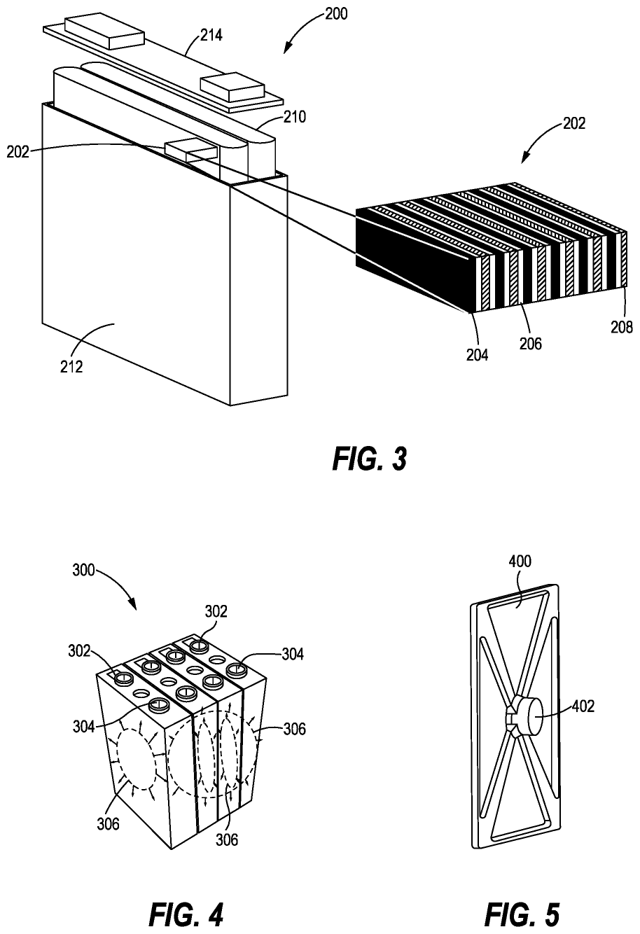

Now referring to FIG. 3, a perspective cut-away of a Li-ion cell 200, according to an embodiment of the disclosure. The Li-ion cell 200 includes a sub-ion-cell 202 including an anode 204 and a cathode 206, separated by a spacer 208. An ion sheet 210 is included to facilitate the movement of ions within the Li-ion cell 200. The Li-ion cell 200 is encased in a shell 212, which ensures physical protection and chemical integrity. A terminal cover 214 safeguards the electrical terminals of the Li-ion cell 200, crucial for maintaining a stable and secure connection within the battery module 100.

The Li-ion cell 200 can be configured in different forms such as prismatic and pouch cells. Prismatic cells are known for their rigid, rectangular casing that offers robustness and efficient space utilization, making them a favorable choice for applications where space and durability are concerns. Pouch cells, on the other hand, are characterized by their flexible, foil-like casing. This design allows for a lighter weight and more flexible form factor in the shell 212, making them suitable for applications where weight and design flexibility are crucial. Both prismatic and pouch cells offer unique advantages and can be selected based on the specific requirements of the application of the battery module 100 or availability in the market.

Now referring to FIG. 4, a pack of Li-ion cells 300 is illustrated, according to an embodiment of the disclosure. This pack of Li-ion cells 300 comprises a plurality of the Li-ion cell 200, each featuring a positive cell terminal 302 and a negative cell terminal 304. A variety of specifications may be set forth by different manufacturers that manufacture the Li-ion cell 200. These specification may include initial compression requirements and end-of-life compression requirements for optimal battery performance. The specifications may differ from varying manufacturers the Li-ion cell 200 and the pack of Li-ion cells 300.

The Li-ion cell 200 and the pack of Li-ion cells 300 often face the challenge of bulging 306, typically caused by the buildup of gases inside the Li-ion cell 200 during charging and discharging cycles. This bulging 306 is a significant concern as it can lead to structural deformation of the Li-ion cell 200, potential breaches of the Li-ion cell 200 and the pack of Li-ion cells 300's integrity, and in extreme cases, safety hazards to the battery module 100.

Now referring to FIG. 5, a compression plate 400 within the battery module 100 is illustrated, according to an embodiment of the disclosure. The compression plate 400, in conjunction with a stopper 402, is positioned in the battery module 100 to apply a uniform force on the pack of Li-ion cells 300 within the module. This uniform application of force is essential in managing the expansion tendencies of these cells, commonly observed during their operational lifecycle. The design of the compression plate 400 is tailored to align with the specific dimensions and configurations of the battery module 100, ensuring effective integration and functionality. This alignment aids in maintaining the stability and operational efficiency of the li-ion cells 300, thereby enhancing the overall performance and extending the service life of the cells. The stopper 402 may extend from the compression plate 400, as a cylinder, rectangular, or other shape generally known in the arts. Pressure may be applied to the stopper 402 to place the compression plate 400 in a desired position. Pressure may be applied to a free end of the stopper 402 to compress the pack of Li-ion cells 300 via the compression plate 400. The free end may be sealed to the battery module 100 when the compression plate 400 is in a preferred position applying a minimum compression pressure for the beginning and end-of-life of the battery module 100.

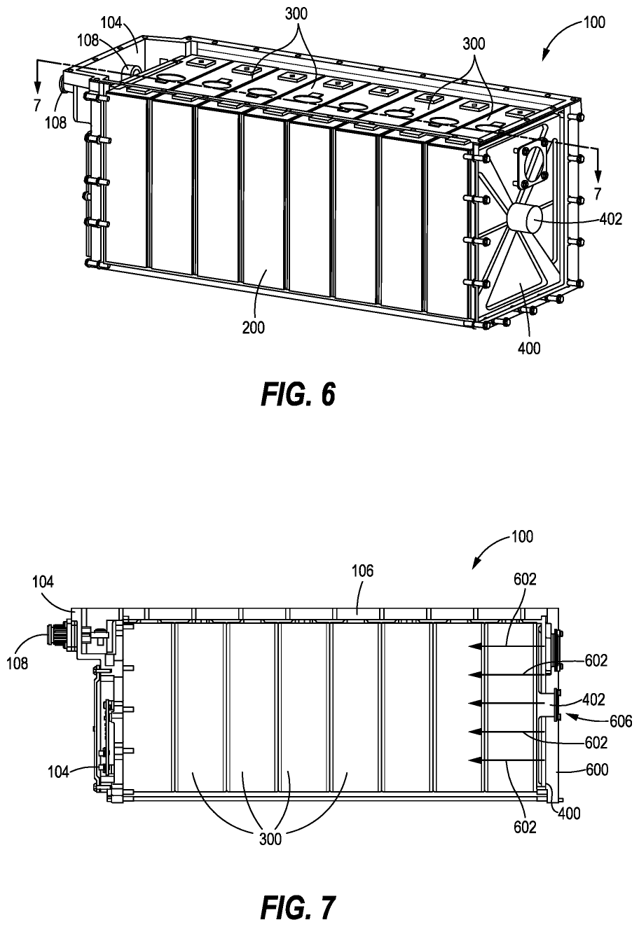

Now referring to FIG. 6, a perspective cut-away view of the battery module 100 taken along line 6-6 of FIG. 2 is illustrated, according to an embodiment of the disclosure. FIG. 6 illustrates the internal structure of the battery module 100, as well as the configuration and placement of the plurality of the Li-ion cells 300 within the frame 102. The assembly of these Li-ion cells 300 is strategically designed to optimize both their individual and collective performance within the battery module 100. Each cell in the pack of Li-ion cells 300 are aligned in a manner that can receive uniform distribution of pressure. The compression plate 400 is engineered to apply consistent and constant pressure across the pack of Li-ion cells 300, which is essential for counteracting potential cell expansion that causes bulging 306 while ensuring consistent electrical output. This uniform pressure distribution is crucial for prolonging the operational life of the Li-ion cells 300 and maintaining the module's overall efficiency.

The frame 102, the front cover 104, and the top cover 106 are designed to encase the Li-ion cells 300 and related elements, providing a protective barrier against external environmental influences while maintaining compression for reducing the bulging 306. The frame 102, the front cover 104, and the top cover 106 ensure that the internal components are shielded from physical impact and environmental conditions which could otherwise compromise their functionality and lifespan, such as air, dust, moisture, debris, etc.

The frame 102, designed as a modular and unitary structure, enhances the overall integrity and efficiency of the battery module 100. Constructed as a single, cohesive unit, the frame 102 minimizes potential points of weakness and leakage. The uniformity of the frame 102 is beneficial in maintaining a controlled environment for the packs of Li-ion cells 300 in a single column, ensuring that they are protected from external contaminants and physical damage that could compromise their performance.

When bulging 306 occurs, the unitary design of the frame 102 becomes advantageous by providing robust and seamless structure for a stable support system that can help distribute the stress caused by bulging 306 more evenly. This can mitigate the impact of bulging on the Li-ion cell 200 and the pack of Li-ion cells 300 in the battery module 100 as a whole, thereby enhancing the operational reliability and longevity of the battery assembly. Additionally, the modular nature of the frame 102 allows for adaptability and scalability, accommodating different sizes and configurations of lithium-ion cells as needed for various applications. This versatility, coupled with the strength of a unitary design, makes the frame 102 a critical component in advancing the durability and efficiency of lithium-ion battery modules.

Now referring to FIG. 7, a cross-sectional view of the battery module 100 taken along line 7-7 of FIG. 6 is illustrated, according to an embodiment of the disclosure. A back cover 600 is provided to enclose the battery module 100. The back cover 600. The back cover 600 secures and protects the rear portion of the battery module 100 and holds the compression plate 400 in place for constant applied pressure against the pack of Li-ion cells 300. This facilitates the distribution of a compression pressure 602 across the Li-ion cells 300. The uniform application of the compression pressure 602 maintains the structural integrity of the plurality of the Li-ion cells 300 and preventing potential deformation or damage that could arise from uneven pressure distribution. Moreover, the back cover 600 serves to enclose and shield the internal components of the battery module 100 from external environmental factors, thus preserving the operational efficacy of the Li-ion cells 300. The back cover 600 may be welded, sealed, soldered, bolted, or otherwise attached to the frame 102, as generally known in the arts. A relief cap 604 is provided on the back cover 600 and configured to vent out gases from within the battery module 100 such as if the battery module 100 goes into a thermal runaway condition.

The stopper 402 may extend out through an aperture 606 in the back cover 600 to allow for a piston to apply pressure to meet the manufacture compression specifications of the pack of Li-ion cells 300 so that constant pressure is applied throughout the life of the battery module 100. Once the required pressure is applied to the stopper 402, the compression plate 400 can be maintained in place to provide a compression pressure 602 by bolting, welding, using circlip, or any mechanical method, as generally known in the arts. The back cover 600 includes the aperture 606 which is sealed by the stopper 402 serving as dust and water seal cover. The back cover 600 holds the compression plate 400 in place to provide the compression pressure 602.

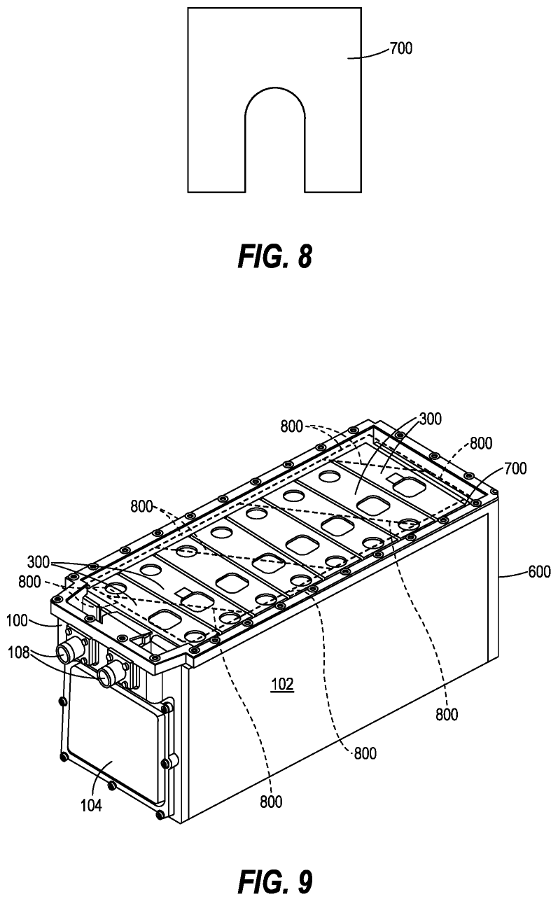

Now referring to FIG. 8, a shim 700 used in the battery module 100 is

illustrated, according to an embodiment of the disclosure. The shim 700 may be a machined component and serves in supporting the compression pressure 602 against the pack of Li-ion cells 300 in the battery module 100. The shim 700 is positioned between the compression plate 400 and the back cover 600. The shim 700 assists in maintaining the position and effectiveness of the compression plate 400. This placement ensures that the compression plate 400 remains securely in place, contributing to the consistent application of compression pressure 602 on the pack of Li-ion cells 300.

Moreover, the shim 700 may be configured to adapt around the stopper 402 that extends from the compression plate 400, allowing for a more tailored fit and efficient transmission of compressive force. By ensuring that the compression plate 400 is held firmly against the pack of Li-ion cells 300, the shim 700 assists in the uniform distribution of pressure throughout the battery module 100 and supports managing the mechanical stresses imposed on the pack of Li-ion cells 300. The integration of the shim 700 into the battery module 100 provides additional stability and operational reliability of the battery module 100, especially in maintaining the desired compression levels over the lifespan of the pack of Li-ion cells 300 purchased from varying manufactures having varying compression requirements and specifications.

Now referring to FIG. 9, a perspective view of the battery module 100 is illustrated with an electric busbar 800, according to another embodiment of the disclosure. The electric busbar 800 is positioned atop the terminal cover 214 of each of the pack of Li-ion cells 300, as generally known in the arts. The primary function of the electric busbar 800 is to facilitate the electrical connection between the positive and negative terminals of the Li-ion cells 300. By linking the terminals across the pack of Li-ion cells 300, the electric busbar 800 enables an efficient and organized electrical pathway throughout the battery module 100. This arrangement is crucial for the coherent and effective operation of the Li-ion cells 300 within the battery module 100, ensuring that electrical connectivity is maintained across the entire assembly.

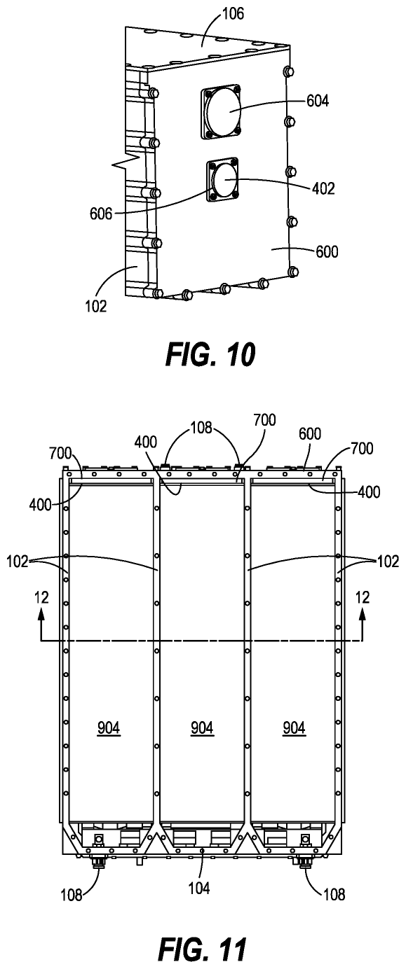

Now referring to FIG. 10, a perspective close-up of the back cover 600 is illustrated, according to an embodiment of the disclosure. The back cover 600 is designed to securely seal the rear of the battery module 100, encapsulating the internal components, including the compression plate 400 and the stopper 402. The stopper 402, sealed to the back cover 600, ensures that the compression plate 400 remains fixed in position by consistently applying compression to the Li-ion cells 300. This consistent compression is essential for maintaining the structural integrity and optimal performance of the Li-ion cells 300.

Now referring to FIG. 11, a top schematic view of a multi-pack battery module 900 is illustrated, according to an embodiment of the disclosure. The frame 102 of the multi-pack battery module 900 is configured to hold a plurality of the pack of Li-ion cells 300 in a plurality of rows, optimizing space utilization and facilitating efficient energy storage. Each row containing a pack of Li-ion cells 300 is designed to fit snugly within the frame 102, ensuring a compact and organized layout. This arrangement not only maximizes the capacity of the multi-pack battery module 900 but also contributes to the ease of assembly and maintenance.

For each pack of Li-ion cells 300, a dedicated compression plate 400 may be provided in each row. This compression plate 400 is essential for applying uniform force across each pack of Li-ion cells 300, thereby maintaining consistent pressure and minimizing the risk of bulging 306 or cell deformation. The compression plate 400's design is aligned with the specific dimensions of each row, ensuring that the pressure is distributed evenly and effectively across the Li-ion cells 300.

Incorporated into each row, the shim 700 may be utilized to further enhance the stability and effectiveness of the compression pressure 602. Positioned between the compression plate 400 and the Li-ion cells 300, the shim 700 supports the maintenance of compression by holding the compression plate 400 in its desired position. This addition of the shim 700 is particularly beneficial in ensuring that the compression pressure is sustained over the lifecycle of the Li-ion cells 300, catering to the varying compression specifications of different manufacturers of Li-ion products. The use of the shim 700 in each row thus plays a significant role in the overall functionality and longevity of the multi-pack battery module 900, ensuring that each row of Li-ion cells 300 remains optimally compressed and functional.

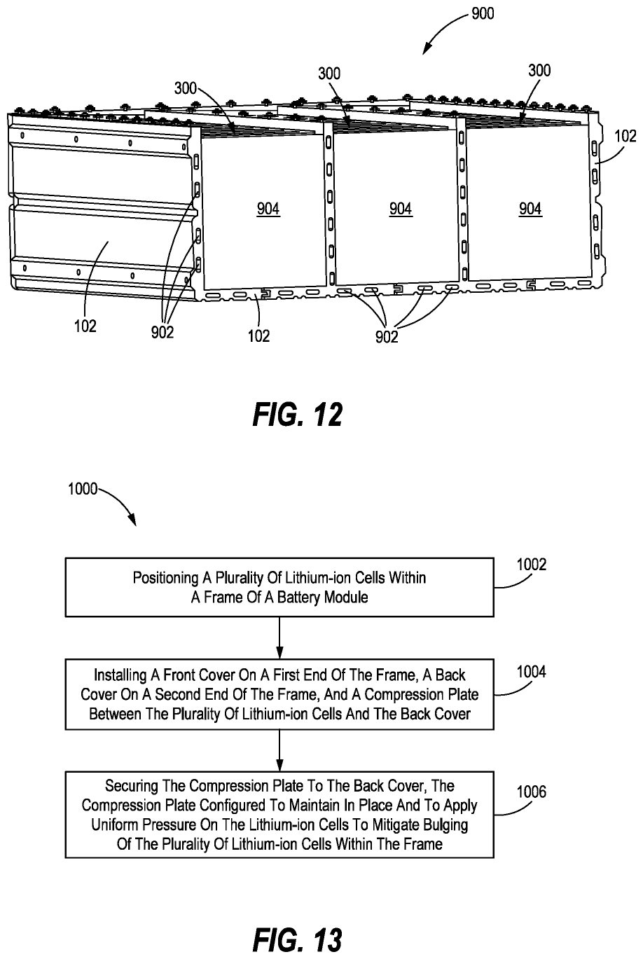

Now referring to FIG. 12, a perspective cut-away of the multi-pack battery module 900 taken along line 12-12 of FIG. 11 is illustrated, according to an embodiment of the disclosure. As shown in FIG. 12, the frame 102 may be formed with multiple rows to accommodate a plurality of the pack of Li-ion cells 300. The frame 102 may be formed with a plurality of cooling channels 902 to allow for coolant to be passed through the plurality of cooling channels 902 to cool the Li-ion cells 300 from the sides and bottom of the frame 102. The plurality of cooling channels 902 may be incorporated into a separate cooling plate configured to the frame 102.

### Industrial Applicability

In practice, the innovative design detailed herein is applicable across a spectrum of industries, encompassing but not confined to sectors such as consumer electronics, electric vehicle manufacturing, energy storage, and portable power supply industries. Specifically, the module structures, Li-ion cell 200, and compression methods of the present disclosure may be utilized in the development and enhancement of battery systems for devices ranging from handheld electronics to electric automobiles, as well as stationary energy storage systems. While the current disclosure addresses the application of Li-ion cells in battery assemblies, the principles and advancements outlined are transferrable to other battery technologies, including but not limited to nickel-metal hydride, solid-state batteries, and supercapacitors.

Now referring to FIG. 13, a flowchart for a method 1000 of assembling the battery module 100 is illustrated, according to an embodiment of the disclosure. In a step 1002, the method 1000 begins with positioning the pack of Li-ion cells 300 within the frame 102 of the battery module 100. In step 1002, the pack of Li-ion cells 300 are arranged within the designated compartments or row(s) in the frame 102 of the battery module 100 or the multi-pack battery module 900, so that each Li-ion cell 200 fits securely and is aligned correctly for efficient electrical connectivity and uniform pressure application.

In a step 1004, the method 1000 continues with the installation of a front cover 104 on a first end of the frame 102 and a back cover 600 on a second end of the frame 102. Additionally, the compression plate 400 is installed between the pack of Li-ion cells 300 and the back cover 600. The front cover 104 serves to protect the pack of Li-ion cells 300 from external environmental elements as well as providing battery terminals 108, while the back cover 600 encloses the opposite end of the battery module 100. The compression plate 600's placement provides the necessary compression pressure 602 against the pack of Li-ion cells 300, ensuring their stability and mitigating bulging 306.

In a step 1006, the method 1000 secures the compression plate 400 to the back cover 600, via the stopper 402 or by using the shim 700 so that the compression plate 400 remains in place to apply uniform pressure on the pack of Li-ion cells 300 for mitigating the bulging 306 of the Li-ion cell 200 within the frame 102.

In the assembly of the lithium-ion cell, a piston may be utilized in precisely positioning the compression plate 400 against the pack of Li-ion cells 300. This process begins by aligning the piston against the stopper 402, which extends from the compression plate 400. The piston is then activated to exert a controlled force on the stopper 402, thereby moving the compression plate 400 into the desired position ensuring that the compression plate 400 applies the necessary uniform compression force to the Li-ion cells 300. This force is calibrated to meet the specific compression requirements set forth by the manufacturer for optimal cell performance and longevity.

Once the compression plate 400 is correctly positioned, achieving the desired compression force, the stopper 402 is securely sealed by welding the stopper 402 to the back cover 600 or through the aperture 606 in the back cover 600. This sealing process is vital to maintain the set position of the compression plate 400, ensuring that the consistent pressure is applied to the Li-ion cells 300 throughout their operational life. Alternatively, the compression plate 400 may be held in position by mechanical fastening or by using the shim 700. In some instances, based on the design and requirements of the battery module 100, the extending part of the stopper 402 may be trimmed or cut post-sealing to maintain the compactness and integrity of the battery module 100 assembly. The use of a piston for precise positioning and sealing of the stopper 402 ensures that the battery module 100 maintains its structural integrity and functional efficacy, required for high-performance battery systems.

The modular approach to the frame 102, such as U-shaped with a single row or with a plurality of rows 904, allows for a high degree of customization to accommodate varying sizes and quantities of the Li-ion cell 200 and the pack of Li-ion cell 200. The U-shaped configuration of the frame 102 is characterized by its open-ended structure, which is pivotal for easy insertion and removal of lithium-ion cells. The frame 102 simplifies the assembly process and also ensures that the cells are securely held in place, enhancing the structural integrity of the battery module 100. Furthermore, the U-shaped frame 102 is designed to provide a support system for the Li-ion cells, with sides of the frame 102 extending upwards to form a protective enclosure and preventing lateral movement of the pack of Li-ion cells 300, thereby minimizing the risk of physical damage and electrical shorts. The shape also enables the frame 102 to accommodate additional components, such as thermal insulators or cooling mechanisms, within its structure, along the interior sides, enhancing the performance and safety of the battery module 100.

In other embodiments, the frame 102 includes the plurality of rows 904, which may be configured as U-shaped rows or columns, each designed to individually house a row or column of the pack of Li-ion cells 300, with all the rows or columns integrated into a single, frame structure as the frame 102. The integration of the plurality of rows 904 multiple U-shaped columns within the frame 102 ensures that each row of Li-ion cells is securely encased within its own U-shaped contour, providing dedicated support and protection. In other embodiments, each of the plurality of rows 904 may include a dedicated compression plate 400, as well as a dedicated top cover 106, battery terminals 108, back cover 600, relief cap 604, shims 700, electric busbars 800, and combinations thereof. This integration of the plurality of rows 904 with Li-ion cells makes the multi-pack battery module 900 suitable for a wide range of applications, from compact portable devices requiring minimal power to extensive, large-scale energy storage systems necessitating substantial power capacity.

The frame 102 may be fabricated as a monolithic structure, utilizing manufacturing processes such as casting, sheet metal operations, or additive manufacturing (3D printing). This design approach allows for the frame 102 to be produced from a single material piece, which can simplify the manufacturing process by reducing the number of components and assembly steps required. The design of the frame 102, whether composed of individual components or as a singular cast or fabricated entity, supports various internal configurations. This includes housing multiple Li-ion cells 200 and integrating components for thermal management, electrical interconnections, and protection mechanisms. The design flexibility accommodates specific requirements for energy storage applications, from portable devices to large-scale energy storage systems.

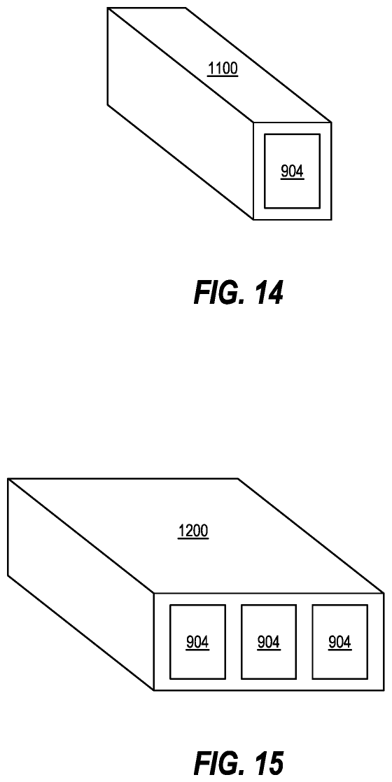

Referring to FIGS. 14 & 15, alternative configurations of the frame 102 are illustrated, according to alternative embodiments of the disclosure. FIG. 14 illustrates a unitary frame 1100 design capable of integrating one of the plurality of rows 904 for a single pack of Li-ion cells 300 and ancillary components into a cohesive structure, suitable for compact energy storage applications. The unitary frame 1100 in FIG. 14 may be the frame 102 of the battery module 100 illustrated in FIGS. 1-2, 6-7, and 9-10. FIG. 15 illustrates a modular frame 1200 comprising the plurality of rows 904, each designed to house a plurality of the packs of Li-ion cells 300, offering scalability for modular energy storage solutions. The modular frame 1200 in FIG. 15 may be the frame 102 of the battery module 100 illustrated in FIGS. 11-12. The front cover 104 and/or the back cover 600 may be formed with the one or both of the ends of the unitary frame 1100 and the modular frame 1200. The front cover 104 and/or the back cover 600 may also be formed separately and configured to attach to the ends of the unitary frame 1100 and the modular frame 1200. The frame 102 may be chosen from a U-shaped frame, the unitary frame 1100, and the modular frame 1200, whereby the battery module 100 may enclose the frame 102 by using at least one of: the front cover 104, the back cover 600, and the top cover 106, with all other components attached and/or assembled for the battery module 100.

In certain embodiments, the modular frame 1200 is engineered to encase a plurality of packs of Li-ion cells 300 along with a plurality of compression plates 400, where the compression plate 400 may be inserted atop the cell array to apply a uniform compressive force, ensuring consistent electrical contact and structural stability across the cell assembly within the frame 102. While the compression plate 400 applies uniform pressure across the Li-ion cells 300, alternative embodiments featuring adjustable or multi-segmented compression plates could offer differential pressure zones. This adaptability would be especially beneficial for modules containing cells of varying capacities, ages, or performance levels.

From the foregoing, it can be seen that the technology disclosed herein has industrial applicability in a variety of settings such as, but not limited to renewable energy, electric vehicle manufacturing, portable electronic devices, industrial machinery, and grid storage system.

What is claimed is:

1. A battery module comprising:
a frame;
a plurality of lithium-ion cells provided within the frame;
a compression plate attached to the frame configured to apply a uniform compression pressure to the plurality of lithium-ion cells in the frame; and
a stopper for holding the compression plate at a holding location for maintaining pressure.

2. The battery module of claim 1, wherein the plurality of lithium-ion cells are one of a prismatic cells and pouch cells.

3. The battery module of claim 1, wherein the stopper is sealed to a back cover for maintaining the compression plate in position to maintain a compression pressure.

4. The battery module of claim 1, wherein the frame includes a plurality of cooling channels.

5. The battery module of claim 1, wherein the frame is one chosen from a U-shaped frame, a unitary frame, and a modular frame, and includes at least one of a front cover, a back cover, and a top cover for enclosing the frame.

6. The battery module of claim 1, wherein the front cover includes a plurality of battery terminals.

7. The battery module of claim 1, further comprising a shim provided between the compression plate and the back cover.

8. The battery module of claim 7, wherein the shim is configured to adapt around the stopper between the compression plate and the back cover.

9. A system comprising:
a work machine;
a battery module for powering the work machine, the battery module having;
a frame;
a plurality of lithium-ion cells provided within the frame;
a compression plate attached to the frame configured to apply a uniform compression pressure to the plurality of lithium-ion cells in the frame; and
a stopper for holding the compression plate at a holding location for maintaining pressure.

10. The system of claim 9, wherein
the battery module is a multi-pack lithium-ion battery module having:
a battery frame;
a plurality of packs of lithium-ion cells provided within the battery frame;
a plurality of compression plates provided at one end of the frame configured to apply a uniform compression pressure individually to each of packs of lithium-ion cells in the frame; and
a plurality of stoppers attached to each of the plurality of compression plates for holding each compression plate at a holding location for maintaining a compression pressure against the plurality of packs of lithium-ion cells.

11. The system of claim 10, wherein each stopper is sealed to the back cover for maintaining each of the compression plates in position to maintain the compression pressure against each pack of Li-ion cells.

12. The system of claim 10, wherein the battery frame includes a plurality of cooling channels.

13. The system of claim 10, the battery frame includes a plurality of battery terminals and the battery frame is one chosen from a U-shaped frame, a unitary frame, and a modular frame and the battery frame further includes at least one of a front cover, a back cover, and a top cover for enclosing the battery frame.

14. The system of claim 10, wherein a plurality of shims are provided between the plurality of compression plates and the back cover.

15. The system of claim 14, wherein the plurality of shims are configured to adapt around the plurality of stoppers between the compression plate and the back cover.

16. A method for assembling a lithium-ion battery module, the method comprising:
positioning a plurality of lithium-ion cells within a frame of a battery module;
installing a front cover on a first end of the frame, a back cover on a second end of the frame, and a compression plate between the plurality of lithium-ion cells and the back cover; and
securing the compression plate in place, via a stopper, to apply a compression pressure on the plurality of lithium-ion cells to mitigate bulging of the plurality of lithium-ion cells within the frame.

17. The method of claim 16, wherein the stopper is connected to the compression plate, further comprising:
applying a force, via piston to the stopper to position the compression plate for applying a desired compression pressure on the plurality of lithium-ion cells; and
sealing the stopper to the back cover.

18. The method of claim 17, further comprising:
providing a shim between the compression plate and the back cover, the shim being configured to adapt to the compression plate and the stopper, for maintaining the compression plate in place to apply a desired compression pressure on the plurality of lithium-ion cells.

19. The method of claim 16, further comprising:
forming the frame as one chosen from a U-shaped frame, a unitary frame, and a modular frame, and attaching at least one of a front cover, a back cover, and a top cover for enclosing the frame;
forming a plurality of cooling channels in the frame; and
installing a plurality of battery terminals in the front cover.

20. The method of claim 16, further comprising:
using a work machine powered by the lithium-ion battery module.
